(19) United States
(12) Patent Application Publication
(10) Pub. No.: US 2009/0038639 A1
(43) Pub. Date: Feb. 12, 2009

(54) Cleaning Device with Qualitative Feedback

(76) Inventors: Amoolya L. Yetukuri, Rochester Hills, MI (US); Arjun V. Yetukuri, Rochester Hills, MI (US)

Correspondence Address: Arjun Yetukuri, 194 Sandalwood Dr, Rochester Hills, MI, 48307, US

(21) Appl. No.: 11/837,338

(22) Filed: Aug. 10, 2007

(51) Int. Cl. B08B 1/00; A46B 9/04; A47L 25/00

(52) U.S. Cl. 134/6; 15/104.001; 15/167.1

(57) ABSTRACT

A cleaning device such as a brush that can be moved in at least one direction between a plurality of positions over a surface receiving the cleaning is disclosed. Cleaning device can comprise a cleaning portion and a feedback unit. Cleaning portion can further comprise at least one cleaning member. Feedback unit is capable of providing qualitative feedback such as a letter grade about the cleaning process. In prior art, several inventions have made positive attempts towards making the activity of brushing teeth more productive, especially for the kids. However, they are deficient in coupling the brushing activity with the policing functionality of the invention. In this invention, qualitative feedback is provided while coupling the cleaning process with policing functionality of such an invention.

### BACKGROUND

1. Field of the Invention

The field of invention relates to a cleaning device such as a brush that can be moved in at least one direction between a plurality of positions over a surface receiving the cleaning.

2. Description of Related Art

Cleaning devices are made in different forms for different applications. A cleaning device can be a brush. Brushes are typically used for cleaning other objects. There are different kinds of brushes for different applications. Brushes may have multiple cleaning members known in the art as bristles or a single cleaning member that can be a surface of a suitable material. Brushes may also have a portion of the brush that is not used for cleaning, but for holding the brush. Cleaning components can be soft or hard depending on the application. A brush used for cleaning a hard surface such as ground may have hard bristles. Relatively speaking, a brush used to clean a painted surface such as the exterior of an automobile may require a brush with a soft cleaning surface. In one of the embodiments of this invention a toothbrush is described as a cleaning device.

Toothbrushes are used to clean teeth. A toothbrush can be motorized or manual. In both types of toothbrushes, the toothbrush is moved between multiple positions in multiple directions to achieve the desired cleaning effect. It is well known in the art that teeth need regular, thorough, and frequent cleaning. Dentists recommend that teeth be cleaned with a suitable toothbrush for specified duration and in specified motions. Lack of frequency, regularity, and by not following the prescribed methods and duration, teeth are prone to decay, discoloration and can result in dental problems such as cavities.

There are several kinds of toothbrushes, mouthwashes, and tooth pastes in the market to help make the process of brushing teeth more productive. There are brushes with soft bristles and some with hard or stiff and some with a combination of both to suit individual preferences and needs. There are toothbrushes in different shapes and sizes to suit different ages and preferences. There are brushes with cartoon character shapes molded into the handles to increase kids' interest in brushing.

In prior art several inventions have made positive attempts towards making the activity of brushing teeth more productive, especially for the kids. U.S. Pat. Nos. 2,501,822 and 5,864,288 describe inventions that attempt to draw kids' interest in brushing using music as the lure or motivating factor. These inventions describe a toothbrush holder where the toothbrush is stored. The toothbrush holder will play music when the toothbrush is removed from the holder. Patent 20060104456 describes a musical toothbrush wherein the music stored in the body of the toothbrush is transferred through the interior of the mouth to the ears. Several music files can be added to the toothbrush to make the brushing activity interesting. But these inventions do not ensure a thorough brushing and do not provide a qualitative feedback.

U.S. Pat. Nos. 5,184,959, 5,570,325, 5,864,288, 6,923,409 use a time constraint to extend the brushing activity up to a predetermined time limit. In U.S. Pat. No. 5,184,959, an alarm will sound after a predetermined amount of time has lapsed. The feedback is an audible signal. The intention of this method is to direct the user to continue brushing until the alarm sounds. In U.S. Pat. Nos. 5,570,325 and 5,864,288, the feedback is a visual display of time. The latter uses a flashing light to warn the user if the brush is placed back in the holder before the predetermined time has lapsed. In U.S. Pat. No. 6,923,409, a similar methodology is adopted to ensure brushing is done for a predetermined time.

Although these inventions in the prior art have made positive attempts to ensure a thorough brushing activity, they are deficient in coupling the brushing activity with the policing functionality of the invention. Only quantitative analysis of the cleaning process is performed. For example, the invention described in U.S. Pat. No. 5,184,959 the invention merely counts time.

In U.S. Pat. Nos. 5,864,288 and 6,923,409 an attempt is made to force the brushing activity for a set period of time by not allowing the storage of the toothbrush. In the above inventions, the user can brush improperly for the predetermined time and satisfy the requirement of the invention, but render the intention of the invention counter-productive. Hence these inventions cannot ensure a thorough and productive brushing. In these inventions described in the prior art, qualitative feedback is absent.

In this current invention, the goal is two-fold. Firstly, the goal of this invention is to provide qualitative feedback which is expected to couple the cleaning process with policing functionality of such an invention.

Secondly, the goal is to motivate the user, especially kids to brush their teeth regularly and well by providing them feedback on how well they brushed their teeth in a fashion that they are very familiar with, grades such as A, B, and so on. Kids typically get excited when they score a good grade on assignments and/or tests. One of the objectives of this invention is to generate similar kind of excitement among kids when they brush their teeth which in turn will motivate them to brush regularly and well.

### BRIEF SUMMARY OF THE INVENTION

In this invention a cleaning device such as a brush is described. The present invention offers improvements over prior art by allowing qualitative assessment and providing qualitative feedback of brushing activity. Qualitative feedback is an indicator of how well the cleaning activity was performed. In one of the embodiments the cleaning device comprises a cleaning portion where in the cleaning portion is located proximate a cleaning receiver and is movable between a first position and a second position. The cleaning device comprises a feedback unit that is capable of providing evaluation of cleaning activity. Cleaning device comprises a processor unit capable of evaluating information about said cleaning activity and generating feedback information. Cleaning device also comprises a power unit and a sensing unit that is capable of sensing movement of cleaning portion. Several criteria can be used for generating feedback. Criteria can be at least one of total time taken for brushing, total number of cycles or total number of directional changes of the cleaning device during cleaning operation, and number of cycles at each location. The limits for the criteria can be pre-set or can be set by the user. After the cleaning operation is completed the quality of cleaning operation is evaluated based on the criteria and an assessment or rank or grade is presented to the user.

### BRIEF DESCRIPTION OF DRAWINGS

FIG. 1 is a schematic of a cleaning device with a feedback unit with possible feedback content mediums.

FIG. 2 is a schematic of a cleaning device and the directions of motion.

FIG. 3a is a schematic of feedback content, circles of varying sizes and shades.

FIG. 3b is a schematic of feedback content, bars.

FIG. 3c is a schematic of feedback content, concentric circles.

FIG. 4 is a schematic of feedback content medium, a dial with feedback content indicator.

FIG. 5 is a schematic of a cleaning cycle.

FIG. 6 is a schematic of a cleaning receiver, teeth.

FIG. 7 is a schematic of a cleaning device with a pressure receiving member.

FIG. 8 is a schematic of a cleaning device with memory storage unit and memory output unit.

FIG. 9 is a block diagram of feedback unit and associations of various components.

### DESCRIPTION OF THE INVENTION

In this section, a detailed description of the embodiments and drawings is provided. Embodiments described herein are to describe the best modes of practicing the invention currently known to the inventor. It is to be understood that the present invention can be embodied in various alternate forms. It is also to be understood that this invention is not limited to the specific embodiments and methods described herein. Therefore, the specific details disclosed herein are not to be interpreted as limiting, but merely as a representative basis for any aspect of the invention and/or as a representative basis for teaching one skilled in the art to alternately employ the current invention. Also, the terminology used herein is used only for the purpose of describing the specific embodiments of the current invention and is not intended to be limiting in any way. Furthermore, the drawings referenced in this section are not necessarily to scale.

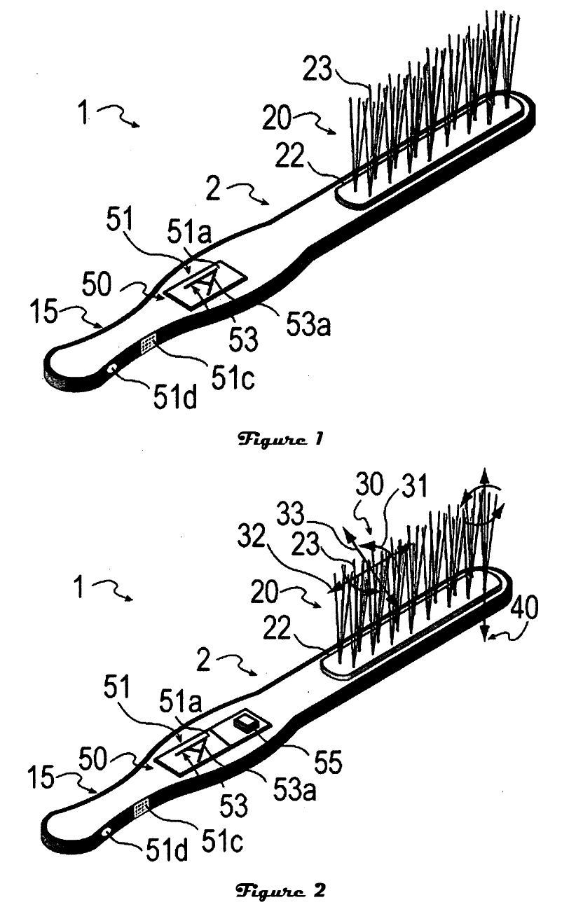

In this invention, a cleaning device with qualitative feedback is described. As an illustration of the invention a specific cleaning device commonly used, a toothbrush is described. It is easily understandable for anyone versed in the art that various aspects of this invention are applicable to any generic cleaning device. In FIG. 1 of this invention, a schematic of a cleaning device unit 1, a toothbrush 2, is shown. Toothbrush 2 can be a conventional toothbrush or a mechanical toothbrush operable with a rechargeable battery or a replaceable battery. Cleaning device 1 can also comprise a toothbrush receiving unit. Such a toothbrush receiving unit can be a toothbrush holder or in some designs also be a toothbrush battery charger. A toothbrush 2 can comprise a body portion 15 and a cleaning portion 20. The cleaning portion 20 can further comprise a cleaning head 22 and at least one cleaning member 25 operatively connected to cleaning portion 20. In one embodiment cleaning portion 20 can be integral with body portion 15. In another embodiment, the body portion 15 and cleaning portion 20 are rigidly connected without relative motion between body portion 15 and cleaning portion 20.

In another embodiment, the body portion 15 and the cleaning portion 20 are operatively connected with permissible relative motion between body portion 15 and cleaning portion 20. In the embodiments described above cleaning portion 20 can move in at least one directional pattern as indicated by 30 in FIG. 2. The permissible directional pattern can be schematically depicted as rotational directional pattern 31, longitudinal directional pattern 32, and lateral directional pattern 33. These are generic directions indicated by 30 and anyone well versed in the art can understand that the generic directional patterns as indicated by 30 also include multiple variations and combinations of generic directional patterns indicated by 30. In one embodiment, at least one cleaning member 23 can have motion in at least one direction independent of motion of cleaning head 22 as indicated by 40 in FIG. 2.

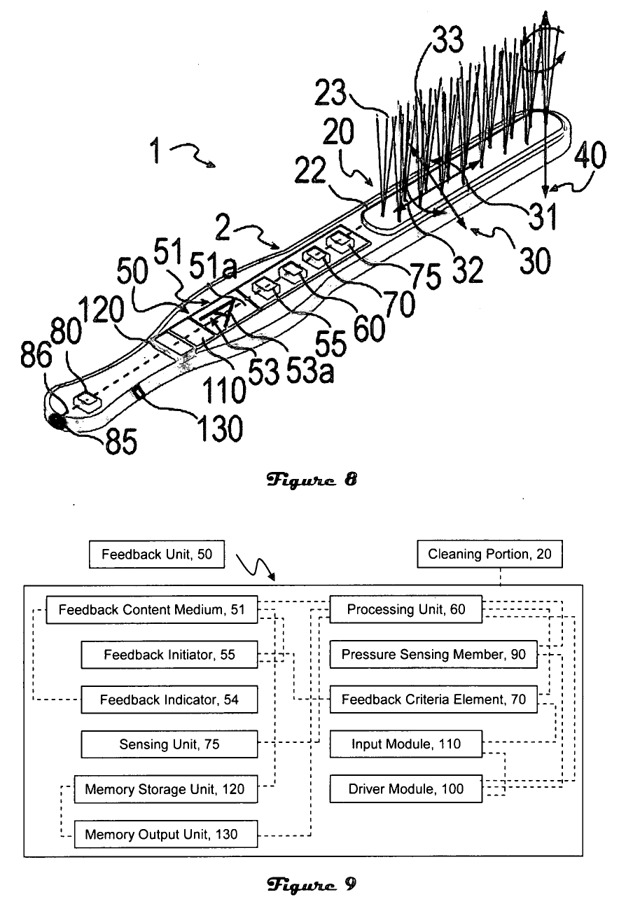

With reference to FIG. 1, cleaning device 1 comprises a feedback unit 50 to provide qualitative feedback. Feedback unit 50 can be present proximate the surface of cleaning device 1 or recessed from the surface of cleaning device 1 or can be enclosed within cleaning device 1 or can be proximate toothbrush receiving unit. Feedback unit 50 can comprise at least a feedback content medium 51, feedback content 53, feedback content indicator 54, and feedback initiator 55. In one embodiment, feedback unit 50 can present feedback content 53 as a certain type of feedback content via a feedback content medium 51. Alternately, feedback unit 50 can present feedback content 53 as a certain type of feedback content via a feedback content medium 51 when signaled by feedback initiator 55 to do so. Feedback content medium 51 and feedback initiator 55 are functionally associated as shown in FIG. 9.

FIG. 2 shows feedback content medium 51 to be a display 51a to present feedback content 53. Display 51a can be a LCD (Liquid Crystal Display) screen. Alternately, display 51a can be an LED (Light Emitting Diode) display screen. Alternately, display 51a can be an OLED (Organic Light Emitting Diode) display screen. In another embodiment of cleaning device 1 feedback content medium presenting feedback can be a transparent surface of suitable material. Feedback content 53 can be visible through such a transparent surface.

Type of feedback content can be at least one of visual, tactile, audible, or other sensory feedback content types such as a taste or smell. It is understood that for anyone familiar with the art that alternate types of feedback or combinations of types of feedback listed above can be used.

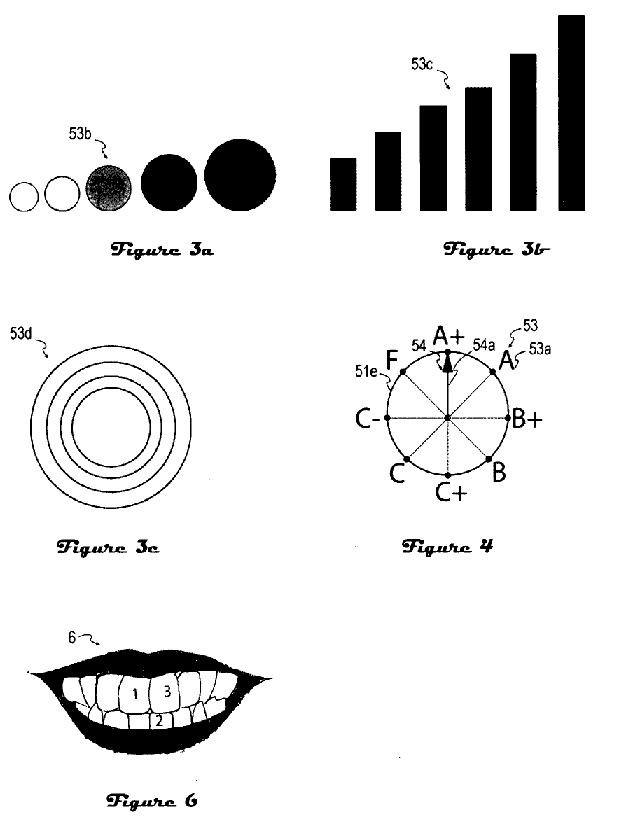

Feedback content 53 of visual feedback content type can be in the form of alphanumeric text 53a such as A+, A, B+, B, C or % as shown in FIG. 1. Alternately, feedback content 53 can be a visual feedback using at least one color to indicate the quality of cleaning operation such as green, indicative of acceptable quality and red, indicative of unacceptable quality. In another embodiment feedback content 53 can be illustrations. One such illustration can be a series of dots 53b, as shown in FIG. 3a, indicative of the quality of cleaning process. In one embodiment such dots can be displayed using LED lights. Another illustration can be a linear illuminating bar or multiple bars 53c, as shown in FIG. 3b, indicative of the quality of the cleaning process. In one embodiment such bars can be LED lights.

Alternately, feedback content 53d can also be illuminated concentric circles of different colors or shades as shown in FIG. 3c. Alternately, feedback can also be text message such as a percentage; for example, 100% being the best and 10% representing a recommendation to brush again. Feedback content can also be in the form of phrases such as “Good,” “Acceptable,” and “Not Good.” The preferred method of visual feedback is with alphabets as described above.

In another embodiment feedback unit 50 can comprise an alternate feedback content medium 51, a speaker unit 51c as shown in FIG. 1 to give audio feedback. In another embodiment, feedback unit 50 can comprise an alternate feedback content medium, an opening 51d on cleaning device 2 through which feedback content 53 in the form of a favorable odor can be emitted indicating an acceptable quality level of cleaning process. In a similar fashion, unfavorable odors can be emitted to indicate an unacceptable quality level of cleaning process. In yet another embodiment, feedback unit 50 with an opening 51d, as shown in FIG. 1, through which smoke of various colors can be released to indicate various quality levels of cleaning process.

Cleaning device 1 can further comprise an alternate feedback content medium such as a plate 51e of a suitable shape with a feedback content indicator 54 such as a pointing device 54a to present feedback by pointing to feedback content 53 marked on plate 51e as shown in FIG. 4. Plate 51e can also be positioned to be visible through feedback content medium such as a transparent surface described earlier. Alternately, feedback content medium 51e and feedback content indicator 54a can be mechanical devices operatively attached to cleaning device 1 or a visual displayed on display 51a. In yet another embodiment of cleaning device 1, feedback content indicator 54 can comprise a fluid. In such an embodiment, fluid can move to feedback content marked as levels on cleaning device corresponding to quality of cleaning process. Alternately, feedback content medium fluid can indicate feedback by feedback content such as a change in color or physical state or by attaining a glow to indicate a level of quality of cleaning process. Although multiple feedback content mediums, types, and content are described here to illustrate the essence of the invention, it is not intended to limit the scope of the invention and anyone familiar with the art can understand that there can be several other ways of providing feedback.

The criteria to enable feedback unit 50 to provide feedback can be one of total number of cycles, number of cycles for each directional pattern, number of cycles at each location, number of directional patterns, number of locations, time taken for each directional pattern, number of times cleaning was performed, time when cleaning operation was performed, total time taken for cleaning operation or time taken at each location. It is obvious to anyone familiar with the art that to determine quality of cleaning operation of alternate embodiments of cleaning device 1, to provide appropriate feedback, additional suitable criteria can be used and the criteria listed above are not to be construed as limiting.

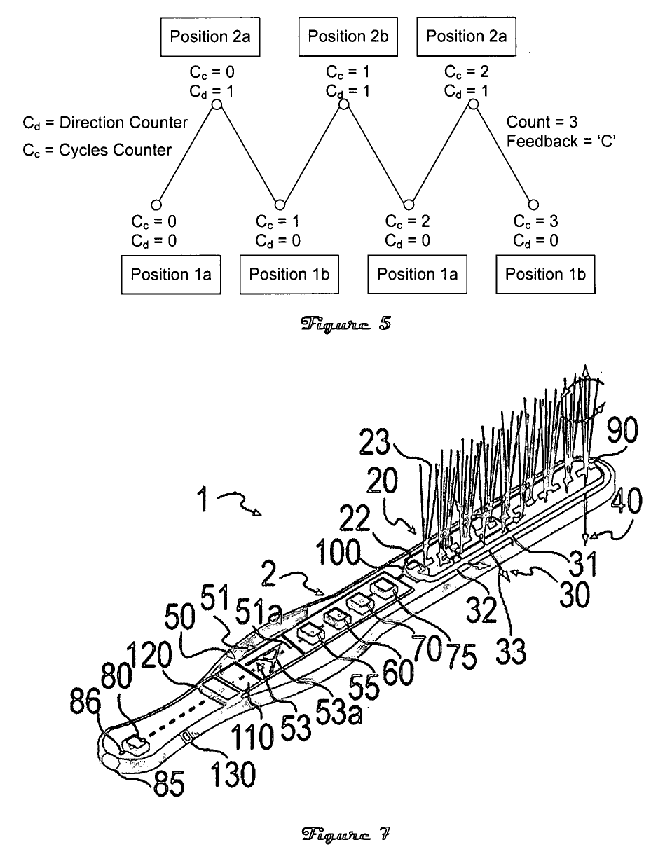

Each cycle is defined as movement of cleaning portion 20 from position 1a to position 2a and to position 1b as shown in FIG. 5. It is easily understandable by anyone familiar with the art that in the return direction position 1b may not closely match initial position 1a from where the movement of the cleaning portion 20 was started. Similarly, second position 2b may not closely match second position 2a of the previous cycle. As shown in FIG. 5, a directional pattern 30 can be movement of cleaning portion 20 from position 1a to position 2a to 1b to 2b and so on. Locations on surface of a cleaning receiver 6 can be as shown in FIG. 6, for instance, denoted by 1, 2, and 3.

Referring to FIG. 7, feedback unit 50 can further comprise a processor unit 60, a feedback criteria element 70, and sensing unit 75 operatively connected to processor unit 60. Processor unit 60 and feedback criteria element 70 are operatively connected. In one embodiment processor unit 60 can be a microprocessor that can receive information from sensing unit 75 and feedback criteria element 70 and generate suitable information for feedback unit 50. Feedback criteria element 70, in one embodiment, can be a counter. Processor unit 60 can rate the quality of cleaning that was performed. Counter 70 can track the number of times the direction of cleaning portion 20 has changed and compute the cycles. In another embodiment counter 70 can count time. Counter 70 can track the time taken for cleaning and processor unit 60 can compare it to a pre-set time limit or a user-set time limit and generate feedback content or grade for feedback unit 50.

In one embodiment sensing unit 75 can be an accelerometer that can sense movement and change in direction of cleaning portion 20. Sensing unit 75 can also be a position sensor using a magnet and a hall effect sensor to check the position of the cleaning portion 20. Sensing unit 75 can also be a proximity sensor. Several sensors are available and anyone familiar with the art can understand the suitability of the application of a specific sensor. Hence, the invention should not be construed as limited to the sensors mentioned above.

With reference to FIG. 7, cleaning device 1 can comprise a suitable power source 80. In one embodiment a power source 80 can be a rechargeable or replaceable battery and is operatively connected to a switch 85 that is placed proximate the surface of the toothbrush 2. Alternately, power source 80 can be charged using inductive charging process. Power source 80 and switch 85 are connected by a suitable interconnection channel 86. Switch 85 can attain ON or OFF status and functions as a switch to turn ON and OFF supply of power from power source 80 to various components of toothbrush 2. ON status of switch 85 enables supply of power from power source 80 which in turn enables at least feedback member 50 to describe quality of cleaning action of cleaning device 1. OFF status of switch 85 disables supply of power from power source 50 to cleaning device 1.

In one embodiment, feedback initiator 55 can be a switch. Feedback initiator 55 is operatively connected to feedback criteria element 70. Status of switch 55 is changeable between a plurality of status. In one embodiment, status of switch 55 is changeable between START status and FINISH status. A START status of switch 54 indicates that cleaning operation is in progress. A FINISH status of switch 55 indicates that cleaning operation is complete. A FINISH status of switch 55 initiates feedback unit 50 to give feedback on how well the cleaning operation was performed using cleaning device 1. Change in status of switch 55 from START to FINISH can be manual or it can be automatic or when toothbrush 2 is returned to toothbrush receiving unit. In another embodiment, feedback initiator can be an input device such as a touch screen to allow user to tap at a location on the screen to request feedback.

With reference to FIG. 8, in a refinement of cleaning device 1, a pressure sensing member 90 is shown. Pressure sensing member 90 is operatively connected to cleaning portion 20. When cleaning portion 20 is placed in contact with cleaning receiver 6, shown in FIG. 6, pressure sensing member 90 is capable of sensing the pressure exerted by the cleaning portion 20 on the cleaning receiver 6. Processor unit 60 is functionally associated with pressure sensing member 90 and a driver module 100 for imparting motion to cleaning portion 20. In one embodiment driver module 100 can comprise a motor and a drive shaft connected to cleaning portion 20 and is capable of moving cleaning portion 20 in at least 1 direction as indicated by 30. A dedicated motor and drive shaft assembly can be used to enable motion of cleaning portion 20 in each of directions as indicated by 30 or a clutch can be used to engage cleaning portion with a single drive shaft to enable motion of cleaning portion in each direction indicated by 30. Alternate ways of moving the cleaning portion 20 are possible and are known to anyone familiar with the art.

When pressure sensing member 90 senses pressure against surface of cleaning receiver 6 it can send an initiation signal to processor unit 60. When processor unit 60 receives an initiation signal from pressure sensing member 90, processor unit 60 can send a signal to driver module 100. When driver module 100 receives an activation signal from processor unit 60, driver module 100 activates cleaning portion 20 in at least 1 direction of motion of 30. Cleaning portion 20 can be activated in alternate directions as shown in 30. Alternately, driver module 100 can be associated with cleaning head 22 and pressure sensing member 90 can send an activation signal to driver module 100 which in turn can activate cleaning head 22. As a result, cleaning head 22 is activated in at least 1 direction of motion of 30. Cleaning head 22 can be activated in alternate directions 30.

In another embodiment, cleaning device 1 can comprise an input module 110, shown in FIG. 8 that can allow the user to select feedback content criteria and associated values. Input module 110 is operatively associated with feedback criteria element 70 and with driver module 100 to control motion of cleaning portion 20. Several input devices are used in the art to allow user to input a desired value. Such input devices can be a touch screen, a dial with a turn knob, a wheel associated with a display screen.

In one embodiment an input module 110 can comprise a counter setting enabler to allow user to input a target number of cycles. Function of counter setting enabler is to allow a target count of cycles be set. So, when cleaning portion 20 is moved between first position and second position in at least one directional pattern 30 at least at one location on the cleaning receiver 6, cycling process continues until target count of cycles enabled by counter setting enabler is reached. Counter 70 in cleaning device 1 can track number of cycles. After target count of cycles is reached, cleaning portion 20 can be stopped from moving between first position and second position by a signal from processor unit 60 to driver module 100. Alternately, a new target counter setting can be enabled for an alternate directional pattern. Qualitative feedback in this embodiment is based on the comparison between the setting of counter setting enabler and number of cycles counted by counter 70.

In a refinement of embodiments of cleaning device 1, an input module 110 can comprise a directional pattern sequencer. Directional pattern sequencer can be an input device to indicate a sequence of directional patterns required for cleaning operation. User can input a desired sequence or select from available patterns presented to the user by directional pattern sequencer. For example, a desired directional pattern sequence can be first, direction indicated by 33, next, direction indicated by 32, and next, direction indicated by 31. When a sequence is enabled by a directional pattern sequencer, a drive signal is sent to driver module 100. Cleaning portion 20 is moved by driver module 100 to follow the selected sequence. Using counter setting enabler a counter setting for number of cycles can be set for each directional pattern in a directional pattern sequence or total number of cycles for all directional pattern in a directional pattern sequence. During cleaning operation in each directional pattern in a directional pattern sequence, the number of cycles is counted and checked against the setting of counter setting enabler. Qualitative feedback in this embodiment is based on the comparison between the setting of counter setting enabler and number of cycles counted by counter 70 for each directional pattern in a directional pattern sequence. Alternately, qualitative feedback in another embodiment can also be based on the comparison between the setting of counter setting enabler for a directional pattern sequence and number of cycles counted by counter 70 during a directional pattern sequence. Alternately, qualitative feedback can also be based on number of directional patterns that a cleaning device is moved along for cleaning process.

In this invention, an alternate embodiment of input module 110 can comprise a location sequence enabler. Cleaning device 1 can be moved from a location, for example location 1 in FIG. 6 on the cleaning receiver to another location, for example location 2 in FIG. 6 by the user of cleaning device 1. Qualitative feedback provided by feedback unit can be based on number of locations a cleaning device is moved to. Alternately, comparison between number of cycles as set by counter setting enabler and cycles counted by counter 70 at each location on cleaning receiver can be used for qualitative analysis of cleaning operation to provide qualitative feedback.

In yet another refinement of cleaning device 1, feedback unit 50 can comprise a memory storage unit 120 and a memory output unit 130. Memory storage unit 120 and memory output unit 130 are operatively connected to processor unit 60. Qualitative feedback provided by feedback unit 50 can be stored for each cleaning operation in memory storage unit 120. Likewise, qualitative feedback provided by feedback unit 50 that is stored in memory storage unit 120 can be retrieved from cleaning device 1 via memory output unit 130. Memory output unit 130 can comprise a port such as a USB port. Alternately, qualitative feedback provided by feedback unit 50 can also be stored in an external memory storage device via memory output unit 130.

In yet another refinement of cleaning device 1, input module 110 can comprise a program input module wherein a cleaning program that is a either a preset program or a learned program can be selected or a user-defined program input into the cleaning device. A cleaning program can comprise one or more feedback content criteria such as target total number of cycles, a directional pattern sequence, a location sequence, number of cycles for each directional pattern sequence, number of cycles for each location, total cleaning time, cleaning time for each directional pattern, cleaning time for each location, or a combination of thereof. For anyone versed in the art, it is understandable that alternate feedback content criteria can be included in a cleaning program.

In a preset program a set of values for one or more of feedback content criteria are presented to the user. Processor unit 60 can possess Artificial Intelligence (AI) capability to acquire cleaning knowledge by recording. In other words, learning actions involved in cleaning process and the associated values corresponding to feedback content criteria. Processor unit 60 that is operatively associated with feedback unit 50 can then provide the user, via input module 110, an option to choose the acquired knowledge as a learned program. With such an enhancement, cleaning process can be performed using cleaning device 1 with minimal user intervention. In a user-defined program, a set of values for one or more of feedback content criteria are chosen by the user.

In yet another embodiment of this invention feedback unit 50 can also provide derivative feedback such as cleaning reward such as financial or points that can be accumulated over a period of time to redeem at a later date for various kinds of rewards. Rewards can be tangible or intangible. For example, reward can be a discount from the manufacturer of the cleaning device or a store, or certain amount of free time at a skating rink. In one embodiment, cleaning reward can be conveyed to the user via feedback content medium such as 51a. Anyone versed in the art can understand that several other rewards can be devised and these examples of rewards are merely illustrative and should not be construed as limiting.

In another embodiment of this invention, feedback unit 50 can also provide yet another derivative feedback such as cleaning advice wherein the user of the cleaning device is given advice on cleaning procedure. In one embodiment, cleaning advice can be conveyed to the user via the feedback content medium 51. A visual or audio message during or prior to cleaning operation can be used to convey cleaning advice to the user of a cleaning device. Cleaning advice can comprise advice on one of feedback content criteria. cm What is claimed is

1. A cleaning device comprising
a cleaning portion movable for cleaning an object
a feedback unit associated with cleaning portion to provide qualitative feedback
whereby the cleaning device can be used for cleaning and informing how well the cleaning was performed.

2. The cleaning device of claim 1, wherein cleaning portion can comprise at least 1 cleaning member operatively connected to said cleaning portion.

3. The cleaning device of claim 1, wherein feedback unit comprises feedback content that is qualitative assessment of cleaning process.

4. The cleaning device of claim 1, wherein feedback unit comprises feedback content medium to present feedback content.

5. The cleaning device of claim 1, wherein feedback unit comprises feedback content indicator.

6. The cleaning device of claim 1, wherein feedback unit comprises feedback content initiator.

7. The cleaning device of claim 1, wherein feedback unit comprises feedback content criteria.

8. The cleaning device of claim 3, wherein feedback content can comprise alphanumeric text.

9. The cleaning device of claim 3, wherein feedback content can comprise audio message.

10. The cleaning device of claim 3, wherein feedback content can comprise a component selected from a group consisting of odor, color, illustration, and combinations thereof.

11. The cleaning device of claim 4, wherein feedback content medium can comprise a display.

12. The cleaning device of claim 4, wherein feedback content medium can comprise a component selected from a group consisting of a transparent surface, a plate, an opening, a speaker, and combinations thereof.

13. The cleaning device of claim 5, wherein feedback content indicator can comprise a pointer.

14. The cleaning device of claim 5, wherein feedback content indicator can comprise a fluid.

15. The cleaning device of claim 6, wherein feedback content initiator can comprise a component selected from a group consisting of switch, an input device, and combinations thereof.

16. The cleaning device of claim 7, wherein feedback content criteria can comprise number of cycles.

17. The cleaning device of claim 7, wherein feedback content criteria can comprise number of locations at which cleaning was performed.

18. The cleaning device of claim 7, wherein feedback content criteria can comprise a component selected from a group consisting of time taken for cleaning, time when cleaning was performed, number of times cleaning was performed, directions, number of directions, sequence of directions, sequence of locations, and combinations thereof.

19. The cleaning device of claim 1, wherein cleaning device comprises a toothbrush.

20. A cleaning device comprising
a cleaning portion movable for cleaning an object
a feedback unit associated with cleaning portion, wherein said feedback unit can comprise
a sensing unit associated with cleaning portion and said sensing unit can sense motion of cleaning portion,
a processing unit associated with sensing unit and said processing unit can use information about said cleaning portion,
a feedback criteria element associated with processing unit to evaluate cleaning process
whereby cleaning device can be used for cleaning and informing how well the cleaning was performed.

21. The cleaning device of claim 20, wherein cleaning portion is movable between a first position and a second position in at least one direction with respect to a cleaning receiver at least at one location proximate cleaning receiver.

22. The cleaning device of claim 20, wherein sensing unit can comprise, a component selected from a group consisting of accelerometer, Hall Effect sensor, proximity sensor, and combinations thereof.

23. The cleaning device of claim 20, wherein feedback criteria element can comprise a counter.

24. A cleaning device comprising
a cleaning portion movable for cleaning an object
a feedback unit associated with cleaning portion, wherein said feedback unit that can provide feedback content can comprise
a sensing unit associated with cleaning portion and said sensing unit can sense motion of cleaning portion,
a processing unit associated with sensing unit and said processing unit can use information about said cleaning portion,
a feedback content criteria element associated with processing unit to evaluate cleaning process,
a pressure sensing member associated with cleaning portion wherein said pressure sensing module can sense pressure exerted by cleaning portion on cleaning receiver,
a driver module associated with cleaning portion,
an input module to allow user to input or select cleaning program that can comprise values for one or more feedback content criteria wherein a feedback content criteria can be used to rate cleaning process of said cleaning device,
a memory storage unit wherein information regarding cleaning operation such as qualitative feedback for cleaning operation can be stored,
a memory output unit whereby information regarding cleaning operation can be retrieved,
a power source wherein power source is capable of providing power to cleaning device,
whereby cleaning device can be used for cleaning and informing how well the cleaning was performed.

25. The cleaning device of claim 24, wherein input module can comprise a component selected from a group consisting of wheel to scroll through a plurality of choices, a display, touchscreen, a button, and combinations thereof.

26. The cleaning device of claim 24, wherein feedback content can comprise a component selected from a group consisting of qualitative feedback, derivative feedback, and combination thereof, wherein derivative feedback can further comprise a component selected from a group consisting of cleaning reward, cleaning advice, and combination thereof.

27. A method for using feedback criteria to perform qualitative assessment of a cleaning process with a cleaning device comprising cleaning portion and feedback unit where in feedback unit further comprises feedback content, the method comprising: performing a cleaning operation using a cleaning device; and feedback unit using feedback content criteria to evaluate the said cleaning process and providing feedback content to indicate how well the cleaning process was performed.
